(19) United States
(12) Patent Application Publication
(10) Pub. No.: US 2025/0159423 A1
(43) Pub. Date: May 15, 2025

(54) FOUNDRY-COMPATIBLE PROCESS FOR A MEMS AUDIO DEVICE

(71) Applicant: Vibrant Microsystems Inc., Cupertino, CA (US)

(72) Inventors: Joseph DOLL, Bend, OR (US); Sanjay BHANDARI, Cupertino, CA (US)

(21) Appl. No.: 18/940,546

(22) Filed: Nov. 7, 2024

Related U.S. Application Data
(60) Provisional application No. 63/597,989, filed on Nov. 10, 2023.

(51) Int. Cl. H04R 31/00; H04R 7/04; H04R 19/00; H04R 19/02; H04R 19/04

(52) U.S. Cl. CPC H04R 31/003; H04R 7/04; H04R 19/005; H04R 19/02; H04R 19/04; H04R 2201/003

(57) ABSTRACT

A method for forming an audio device includes receiving a first wafer with upper and lower portions and having a first cavity, disposing a second wafer upon the first, wherein the second wafer comprises a material having a first and second side, wherein a portion of material is disposed above the first cavity, forming a contact between the material and the first wafer, disposing a third wafer on the second wafer via an adhesive material, wherein a second cavity is formed therebetween with a height approximately equal to the thickness of the adhesive material, wherein the second cavity is disposed above the portion of material, and wherein the portion comprises a diaphragm for the MEMS audio device configured to move out of plane relative to the material and within the first and the second cavity.

### CROSS REFERENCE TO RELATED APPLICATIONS

This application claims priority to Provisional Patent Application U.S. 63/597,989 filed on Nov. 10, 2023, which is hereby incorporated in its entirety for all purposes.

### BACKGROUND OF INVENTION

The present invention is directed to micro electro-mechanical systems (MEMS). In particular, the present invention provides a semiconductor foundry-compatible process to fabricate devices such as a MEMS speaker device and a MEMS microphone device, separately or on a common substrate. Although the invention has been described in terms of specific examples, it will be recognized that the invention has a much broader range of applicability.

Loudspeakers, also referred to as speaker drivers or speakers, are electro-acoustic transducers that convert electric signals to the movement of air. Speakers are an essential part of many consumer gadgets such as home music systems, smart watches or wearables, smartphones, laptops, tablets, earbuds, among others. As the thicknesses of mobile devices, speakers have also become smaller in size. Currently, loud speakers refer to a speaker with greater than 4-inch diameter, mini speakers refer to a speaker with a 2-4 inch diameter, and micro speakers refer to speakers with a diameter less than 2-inches. Recently with the popularity of ear buds, the size of the speakers has decreased to less than 1-inch diameter.

Most conventional speakers are still designed with conventional technologies that include a thin moving diaphragm of paper, plastic, or similar material, and spring element which is actuated by electromagnetic signals that are proportional to an audio signal input to the speaker. Conventional speakers typically use a permanent magnet to generate a magnetic field in which a moving coil (driven with electrical signals) generates transient electromagnetic forces. Conventional speakers are incompatible with conventional surface mount printed circuit board (PCB) technology which is a disadvantage in the manufacturing flow for original equipment manufacturers (OEM) of electronic systems. Additionally, conventional speaker technology creates constraints on the placement of speakers inside smartphones, as an example, as magnets may adversely affect other components in the smartphone such as magnetic sensors and the like. These constraints and other limitations limit the size of conventional speakers and related technologies and prevent them from being used in many consumer devices. MEMS micro-speakers have been developed using piezoelectric which have limitations in frequency response at lower frequencies, larger size and more complex fabrication requirements.

In contrast to speakers, microphones have typically been built using different technologies. In some cases, microphones have utilized condenser/capacitance technology, electret condenser technology, MEMS technology, among others. As such, the inventors of the present invention believe a low cost approach to developing an audio device including both the microphones and speakers in a monolithic device to provide good audio quality in a very small size and low cost needs to be developed. In addition, such a new technology would allow integration of microphones and micro-speakers with the mainstream integrated process.

In light of the above, what is desired are semiconductor fabrication-compatible methods for manufacturing microphones, speakers, and integrated devices themselves.

### SUMMARY OF INVENTION

The present invention is directed to micro electro-mechanical systems, commonly termed “MEMS.” In particular, the present invention provides foundry compatible processes to fabricate a MEMS speaker device, a MEMS microphone, or combined devices and related devices and methods. Although the invention has been described in terms of specific examples, it will be recognized that the invention has a much broader range of applicability.

In an example, the present invention provides a foundry compatible process for fabricating a micro-speaker and a microphone device. The device typically has a cap device comprising a plurality of vent regions for propagating acoustic signals. The cap device can be made of a suitable material such as silicon, or other rigid substrate capable of being processed using semiconductor techniques. In an example, the device has an audio device with a diaphragm and actuator coupled to the cap device. In an example, the audio device comprises at least one vent region (although there may be more) configured to allow back pressure to flow therethrough. The device has a cavity region configured between an interior surface of the cap device and a diaphragm of the device. The audio device has a frame coupled between the cap device and the bottom wafer, referred to as a handle wafer or substrate to form an exterior housing for the cavity region. An example, the frame device can be configured on either or both of the cap device and/or the substrate device or integral with either or both devices.

In an example, the audio device has a movable diaphragm device with a thickness of 0.1 nm to ten microns, and within the cavity region. In an example, the movable diaphragm device has a first surface and a second surface opposite of the first surface. In an example, the movable diaphragm is connected with at least two cantilevers, springs, or other compliant mechanical members. Each of the springs is coupled between a peripheral region of the movable diagram device and a portion of a frame configured surrounding the movable diaphragm device.

In an example, the device has an electrode device configured on the interior region of the substrate. The substrate device may be a CMOS device with an electrode device or devices formed on an interior region of the CMOS device. In some embodiments, the CMOS device includes circuitry for the speaker and/or microphone. In another example, cavities intended for housing the micro speaker and the microphone are etched in the handle wafer, using Deep Reactive Ion Etching (DRIE) process. In an example, the cavity etched handle wafer is bonded to the device wafer forming the diaphragms for the micro speaker and the microphone, with a fusion bonding of the two wafers. In another example, another cavity intended for housing the micro speaker and the microphone are created by using a polymer bonding process to bond two silicon wafers with required gap to define the cavity height

In an example, the surface of the device wafer is grinded down to obtain the desired thickness of the device diaphragm for the micro-speaker and microphone. In an example, the thinning of the device layer is achieved using Chemical Mechanical Planarization (CMP) or Polishing. Alternatively, the device diaphragm can be deposited with the desired thickness as polysilicon or another electrically conductive film using Low Pressure Chemical Vapor Deposition (LPCVD), or the like. The diaphragm may be a composite structure composed of multiple films deposited sequentially. In another example, the top surface and oxide of the processed CMOS wafer is passivated with silicon nitride to protect the processed layers from a later dry etching step of Vapor Hydrogen Fluoride (VHF). In an example, vent holes are etched with DRIE in the substrate or CMOS wafer in the areas identified for speaker and microphone. In some examples, vent holes are etched with the DRIE process in the handle or cap wafer in the areas of microphone & speaker. These vent holes allow the speaker & microphone to pass the sound waves from the device to the external environment. In an example, the diaphragm for speaker and microphone defined by the pattern on the device wafer are released using Vapor Hydrogen Fluoride (VHF) exposure from the vent holes.

In an example, the device has an electrical connection to the cap or the handle layer of the wafer through the metal deposition on the exterior region of the cap wafer. In an example, the device layer or the MEMS diaphragms for the micro speaker and the microphone are driven from the connection of the polysilicon or metal connected to the bond pad on the substrate.

In an example, the cavity for the micro speaker is etched such that the speaker diaphragm moves between the cap surface and the cavity of the handle wafer. In an example, the cavity for the microphone is etched such that the microphone diaphragm moves in the cavity on the handle wafer and the cavity on the cap surface.

Depending upon the example, the present invention can achieve one or more of these benefits and/or advantages. Various embodiments provide a foundry compatible process to fabricate a MEMS Micro-speaker or MEMS microphone that can reduce the size and profile height of the speaker without affecting the performance. Various embodiments can also integrate MEMS Microphone together with the MEMS speaker in the same integrated circuit. In an example, various embodiments can integrate the CMOS audio processing within the same package together with MEMS, thereby miniaturizing the whole audio chain for demanding components such as ear buds, hearables, smartwatches and smartphones. In an example, various embodiments can be implemented using conventional semiconductor and MEMS process technologies for wide scale commercialization. These and other benefits and/or advantages are achievable with the present device and related methods. Further details of these benefits and/or advantages can be found throughout the present specification and more particularly below.

According to one aspect, a method for forming a Micro-Electromechanical System (MEMS) audio device is disclosed. One method may include receiving a first wafer having by an upper and lower portion, wherein a first cavity is formed within the upper portion, and disposing a second wafer upon the first wafer, wherein the second wafer comprises a semiconductor material having a first side and a second side, wherein a diaphragm is formed from a portion of the semiconductor material, wherein the diaphragm is disposed above the first cavity, and wherein the first side of the second wafer is directed towards the upper portion of the first wafer. A process may include disposing a third wafer on top of the second wafer via a thickness of an adhesive material, wherein the third wafer comprises a bottom side and an upper side, wherein the bottom side of the third wafer is directed towards the second side of the second wafer, wherein a second cavity is formed therebetween, wherein the second cavity is disposed above the diaphragm, wherein the diaphragm for the MEMS audio device is configured to move out of plane relative to the semiconductor material and within the first cavity and the second cavity.

According to another aspect, a Micro-Electromechanical System (MEMS) audio device is disclosed. One device may include a first wafer characterized by a first surface comprising a first cavity and a second surface having at least a first vent hole formed through the first wafer and coupled to the first cavity, wherein the first surface comprises a first plurality of electrical contacts, and a second wafer disposed upon the first surface of the first wafer, wherein the second wafer is characterized by a flexible material layer, wherein a portion of the flexible material layer is disposed above the first cavity of the first wafer and has plurality of electrical contacts. An apparatus may include a third wafer coupled to the second wafer using an insulating material, wherein the third wafer includes a second cavity, and having at least a second vent hole formed through the third wafer and coupled to the second cavity, wherein the first portion of the flexible material forms a diaphragm for the MEMS audio device

According to another aspect, a micro-speaker device is disclosed. One device may include a movable diaphragm device composed of one or more sequentially deposited thin films from a first group consisting of: silicon, polysilicon, silicon nitride, or graphene material, and comprising a total thickness of 0.1 nm to ten microns, and configured spatially within a cavity region, the movable diaphragm device having a first surface and a second surface opposite of the first surface, wherein the movable diaphragm is coupled to at least two flexible supports selected from a second group consisting of: cantilever and springs, wherein each flexible support is coupled between a peripheral region of the movable diaphragm device and a portion of a frame disposed adjacent to the movable diaphragm device, and a substrate device coupled to the frame, wherein a first electrode is configured using the substrate or an electrically conductive material deposited on the substrate to provide an electrostatic force relative to the movable diaphragm, wherein movement of the movable diaphragm in response thereto is configured to generate acoustic signals; the substrate device includes a first vent and a first cavity configured to allow back pressure to flow therethrough. An apparatus may include a cap electrode is coupled to the frame with an insulating material selected from a third group consisting of: epoxy, a polymer, and an adhesive, wherein the cap electrode includes a second vent and a second cavity region is formed between the cap electrode and the movable diaphragm device, wherein a height of the second cavity is determined in response to a thickness of the insulating material, and wherein the cap electrode includes an electrode on a top surface of the cap electrode, wherein the cap electrode is configured to provide an electrostatic force relative to the movable diaphragm, wherein movement of the movable diaphragm in response thereto is configured to generate acoustic signals from the first vent or the second vent.

### BRIEF DESCRIPTION OF FIGURES

In order to more fully understand the present invention, reference is made to the accompanying drawings. Understanding that these drawings are not to be considered limitations in the scope of the invention, the presently described embodiments and the presently understood best mode of the invention are described with additional detail in the accompanying drawings:

FIG. 1 is a simplified diagram of some embodiments;

FIGS. 2A-D illustrates results of process steps according to some embodiments of the present invention;

FIG. 3 shows a Microphone device using the present invention;

FIG. 4 shows a combined speaker and microphone device; and

FIG. 5 shows a System IN Package (SIP) device using an embodiment.

### DETAILED DESCRIPTION

According to various embodiments, techniques directed to fabrication of an integrated micro-speaker and microphone using Micro-Electro mechanical Systems “MEMS” are provided. In particular, some embodiments of the present invention disclose a Foundry compatible process for fabricating a MEMS speaker device and/or a MEMS microphone device. The terminology micro-speaker and speaker has been interchangeably, both implying a device that can generate sound waves. The invention has been described in terms of specific examples, but it will be recognized that the invention has a much broader range of applicability.

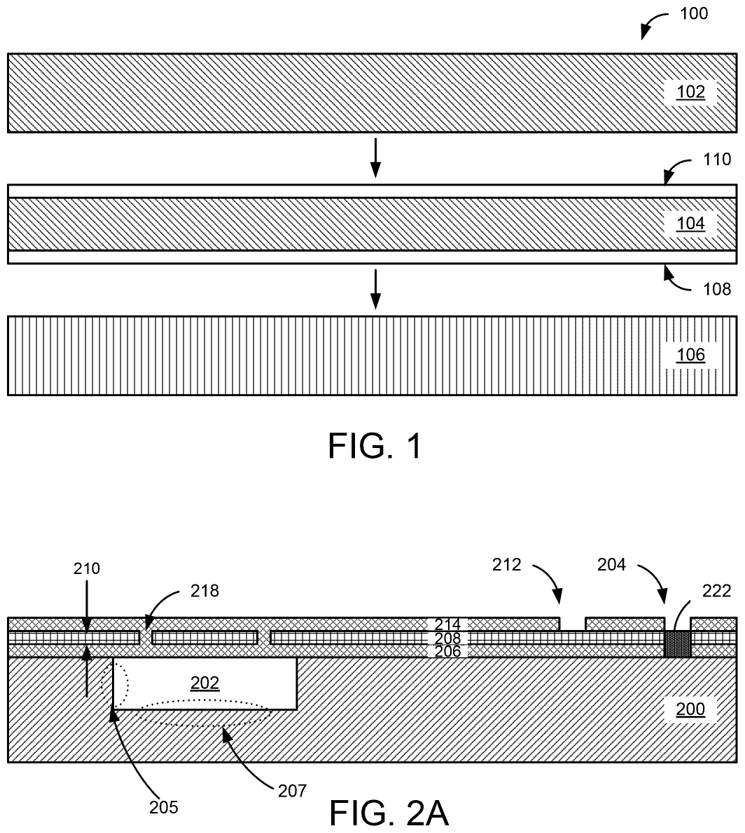

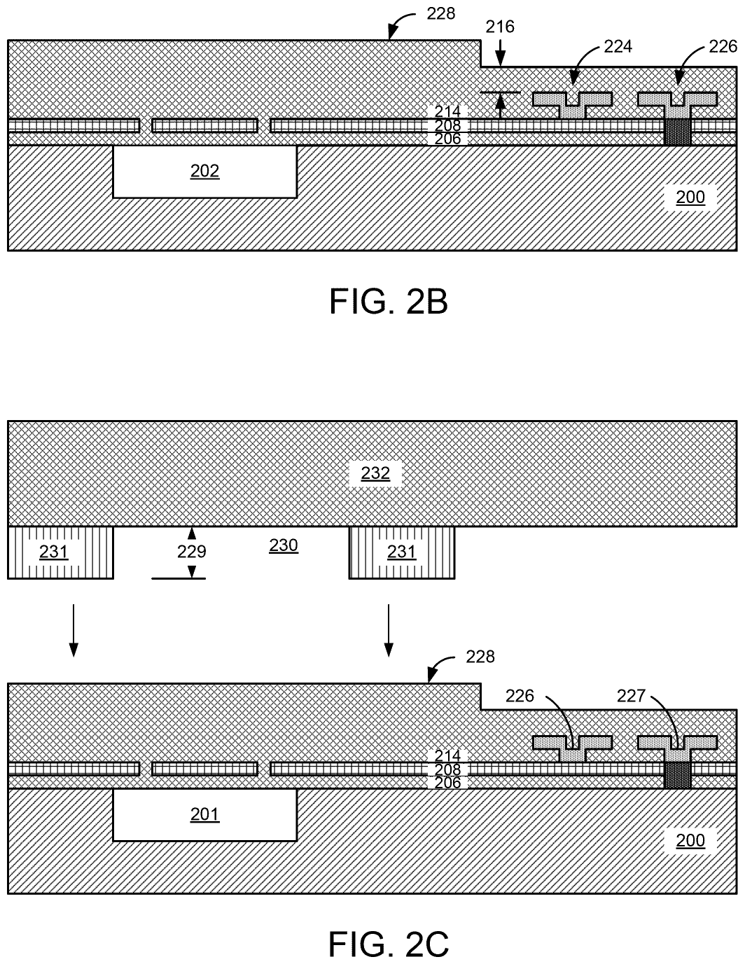

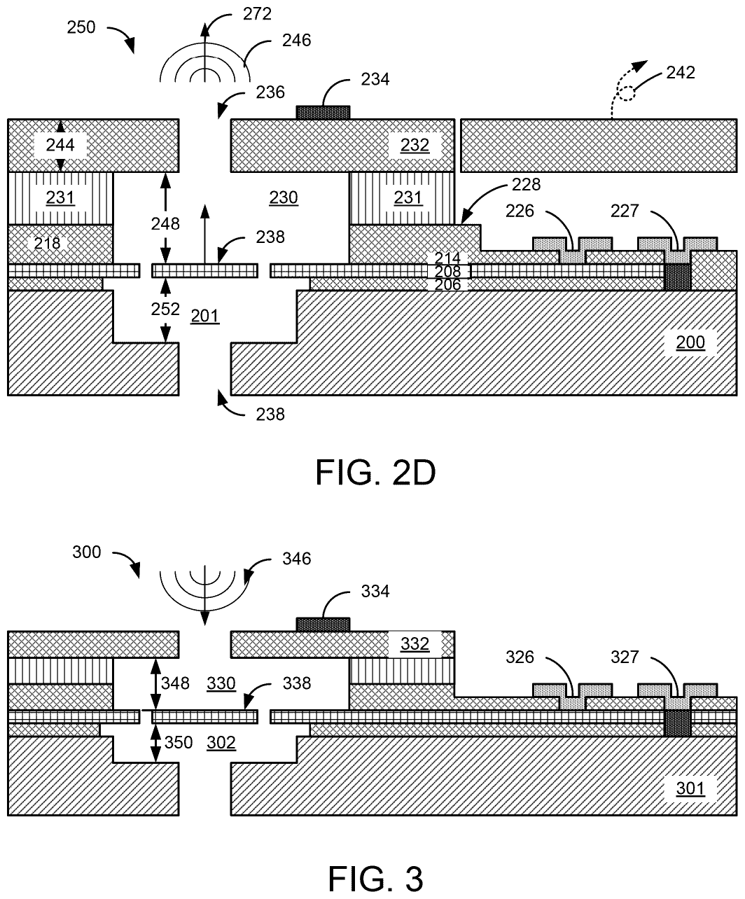

FIG. 1 is a simplified diagram showing a set of wafers that are used in the fabrication of the process described in some embodiments. A device 100 typically includes a MEMS handle wafer 106, a device wafer 104 (with oxide layers 108 and 110), and a lid wafer 102. In some embodiments, material layers 108 and/or 110 may be an oxide, such as silicon oxide, a nitride, such as silicon nitride, or other material that may be etched (e.g., vapor etched), as disclosed below. In some embodiments, wafers 102, 104 and 106 are silicon-based wafers/media. In other embodiments, wafer 104 may be semiconductor, polysilicon, carbide, graphene, or the like. For sake of convenience, reference to oxide layers 108 and 110 and semiconductor material wafer 102, 102, and 106, are used below. In some embodiments, lid wafer 102, handle wafer 106, MEMS device wafer 104 may be processed together or asynchronously from each other. In an example illustrated in FIGS. 2A-D, lid wafer 102, MEMS wafer 106 and device wafer 104 may be processed, combined, and further processed. The combination may then be bonded with a CMOS or substrate wafer and then further processed.

FIGS. 2A-D illustrate results of various foundry-compatible processing steps of embodiments of the present invention. FIG. 2A illustrates a handle wafer 200, with cavity 202 intended for housing an audio device such as a micro speaker and a microphone. In various embodiments, cavity 202 are etched from handle wafer 200 typically using one separate mask and one Deep Reactive Ion Etching (DRIE) processes which may result in cavity 202. In some embodiments, the planar dimension of the cavity and the depth of a cavity for a microphone embodiment may be different than for a speaker embodiment. As an example, the cavity depth for the microphone may be less than one micron to a few tens of microns which may be shallower than the cavity depth for a speaker. The area for the cavity etch is typically defined using a photolithography process using a mask associated with this step. In some embodiments, if two or more micro-speakers are to be formed within wafer 200, then one mask and one DRIE processes may only be needed to accomplish forming the two or more cavities in this step.

In some embodiments, a series of grooves, bumps, ridges or other type of geometric structure may be etched or formed on the sidewalls and/or bottoms of cavity 202. These structures may be used to inhibit stiction of a movable diaphragm (discussed below), disposed within cavities 202 with respect to the sidewalls (e.g., 205) or bottom (e.g., 207) of cavity 202.

FIG. 2A also illustrates a device wafer (e.g., device wafer 104 typically having oxide layers 108 and 110) bonded to wafer 200. In some cases, a fusion bonding process may be used. In this example, oxide layer 108 appears as oxide layer 206, and device layer appears as diaphragm layer 208. Specifically, after the wafer bonding, oxide layer 110 and a portion of device layer 104 are grinded down to obtain the desired thickness 210 for a diaphragm layer 208, e.g., the silicon of a silicon on insulator (SOI) wafer is thinned down to thickness 210. This process step can be accomplished, for example, using Chemical Mechanical Planarization (CMP), polishing, or the like. In various embodiments, portions of diaphragm layer 208 are used as a diaphragm for a micro-speaker, a microphone, or the like. In various embodiments, an initial thickness of the device wafer 104 may be a few hundred microns, and a thickness 210 of diaphragm layer 208 can range from fractions of micrometers to a few micrometers. In some embodiments, the device diaphragm layer 208 can be deposited with the desired thickness as polysilicon using Low Pressure Chemical Vapor Deposition (LPCVD), or the like on top of oxide layer 206, rather than being thinned from an existing thick layer of silicon (e.g., SOI).

FIG. 2A also illustrates a result of deposition, process and etch processes. In various embodiments, photoresist layers may be deposited and patterned upon layer 208 and then one or more etching processes (e.g., reactive ion etching (RIE) process) can be performed on the silicon layer 208 to define various spring areas for the MEMS device e.g., 218, 220 etc.

In some embodiments, subsequent to forming the spring areas 218 and 220, an oxide layer 214 may be disposed or formed upon the resultant structure. In the example in FIG. 2A, a thermal oxidation is performed over the resultant structure (e.g., upon diaphragm layer 208 and within trenches 218, 220, etc. within wafer 200) to form oxide layer 214. As illustrated, with thermal oxidation, oxide layer 214 may form uniformly on the walls within the trenches.

FIG. 2A also illustrates a result of subsequent process steps. Specifically, in various embodiments, a Reactive Ion Etching (RIE) may be performed on oxide layer 214 and oxide layer 206 to create additional trenches, e.g., 204, 212, and a conductive material layer 222 may be deposited on top of the handle wafer and etched away. In some instances, the conductive material layer 222 forms a conductive plug and may be conductive polysilicon or other conductive material. In some embodiments, material layer 222 may be formed in a number of ways, such as deposited in a high temperature epitaxial reactor (epi-poly) or deposited at lower temperature with the process of Low Pressure Chemical Vapor Deposition (LPCVD), or the like.

FIG. 2B illustrates a result of subsequent process steps. In various embodiments, a conductive metal such as aluminum is sputtered to create contact areas such as bond pads 226 and 224 within trenches 212 and 204, respectively. This may be performed by a sputter followed by a mask and etch, a mask followed by an etch and clean, or the like. This step may be followed by a Plasma Enhanced Chemical Vapor Deposition (PECVD) oxide deposition process which creates top oxide passivation layer 228. As shown in FIG. 2B, a height of layer 229 may be controlled 216 above bond pads 226 and 224.

FIG. 2C shows processing using lid wafer 102 previously shown in FIG. 1 where a polymer adhesive 231 is patterned on a wafer 244. The polymer can, for example, be an epoxy photoresist material, or other non-conductive material. In some embodiments, the height 229 of the polymer layer 231 forms a cavity 230 between the inner surface of the lid wafer 102 and the device wafer 200 where the polymer is bonded.

FIG. 2D shows a result of additional processes. Passivation oxide 228 on handle wafer 200 may also be thinned such that bond pads 226 and 227 may be exposed. Lid wafer 232 is then bonded on the top surface of passivation oxide 228. In some cases, the lid wafer 232 may then also be thinned down with CMP to a reduced thickness labeled 244. Subsequently, a conductive material, e.g., metal, 234 is deposited and patterned on cap 232, as shown.

In various embodiments, a DRIE process is applied to the cap wafer 102 to create one or more vent openings 236 as well as weaken a portion 242 of cap 232. This weakened portion 242 of cap 232 is then singulated or removed from lid wafer 232 outside of the cavity region (e.g., 230). A similar DRIE process may be applied to handle wafer 200 to create one or more vent holes 238 on the back side of wafer 200, as shown.

FIG. 2D also illustrates a result of the following processing steps. In various embodiments, combined wafer 250 may then be processed with a Vapor Hydrogen Fluoride (VHF) etch. As mentioned above, the multiple openings (e.g., 236, 238, etc.) are configured to allow VHF to be channeled between lid wafer 232 and wafer 200. In operation, the VHF is used to etch away portions of oxide layers 206 and 228. In particular, portions of oxide layers 206 and 228 surrounding diaphragm 238 and associated spring elements are etched away. As a result of the above processes, diaphragm 238 is suspended by the spring elements to handle wafer 200 and can move up and down in an out of plane direction within cavity 230 and cavity 201.

In various embodiments where the audio device is a micro-speaker 250 as shown in FIG. 2D, the diaphragm 238 acts as a speaker diaphragm that can be electro-statically actuated to generate sound pressure. Vent holes, e.g., 236 and 238 respectively allow soundwaves 246 to pass outwards 272 from the micro speaker diaphragm 238 to the external environment. In some embodiments, a distance between diaphragm 238 and the cap is height 248. Further, a distance between diaphragm 238 and the upper surface of the cavity 201 is height 252. In one embodiment, height 248 may be the same or different from height 252. In some embodiments, height 248 and 252 may be within a range of 1 micron to 40 microns. In some embodiments, the height 248 is substantially similar to the height of the polymer material 231 used for adhesion.

In some embodiments, micro speaker may be driven by three different signals: speaker_top, speaker_dia (diaphragm), and speaker_bottom, which may be provided from external sources or internally provided. In this example of FIG. 2D, cap wafer 232 provides speaker_top signal. Speaker_top signal is coupled to the top portion 232 of micro speaker cavity 230 via metal 234. Speaker_dia signal is coupled to contact 226 and to diaphragm 238 of micro speaker via the above-mentioned spring/suspension structures. Additionally, a speaker_bottom signal is coupled to contact 227 and to a bottom portion (e.g., backplate 200) of micro speaker cavity 201. In operation, the audio signals on speaker_top and speaker_bottom are in-phase and speaker_dia, may be held at a constant, e.g., dc voltage. As an example, speaker_top may vary in time: 20V, 40V, 20V, 40V, while speaker_bottom may vary in time: 0V, 20V, 0V, 20V, and speaker_dia may be held at 20V. In other embodiments, the bias voltages and amplitudes of speaker_top, speaker_bot, and speaker_dia may vary. In one example, the differential signals of speaker_top and speaker_bot cause speaker diaphragm 338 to move out-of plane (e.g., upwards and downwards within micro speaker cavity 201 and 230, thus producing sound.

FIG. 3 illustrates an embodiment where the audio device is a microphone 300. In this embodiment, the microphone diaphragm labeled as 338 is suspended and can move relative to a backplate on wafer 301 to sense sound pressure 346. As can be seen in FIG. 3, a distance between diaphragm 338 and backplate (electrode) is height 350. Further, a distance between diaphragm 338 and the lid 332 is height 348. In some embodiments, height 350 may be within a range of 0.1 to 5 microns, and the height 348 may be within a range of 0.1 to 20 microns. In some embodiments, the sensing may be done using an electrode on the back plate 301 coupled to the metal 327, or may be done with the lid cap 332 used as an electrode coupled to the metal 334.

In some embodiments, microphone 300 may be driven/sensed by three different signals: mic_top, mic_dia, and mic_bottom, which may be driven/sensed from external sources or internal sources. In this example, FIG. 3, terminal 334 provides a mic_top signal, contact 326 is coupled to a mic_dia signal 438, and contact 327 is coupled to a mic_bottom signal. The mic_top signal is connected to terminal 334 which is electrically coupled to the top portion 332 of microphone 330 cavity. Further, the mic_dia signal is coupled to contact 326 which may be coupled to the diaphragm 338 of microphone 300 via the above-mentioned spring/suspension structures. Additionally, the mic_bottom signal is coupled to contact 327 which may be coupled to the backplate 301. In operation, a DC bias voltage may be applied to mic_bottom and/or mic_dia, and when microphone diaphragm 338 moves out-of-plane movement (e.g. upwards and downwards) in response to a received sound, a change of capacitance across mic_dia via contact 326 and mic_bottom via contact 327 and 301, and/or a change of capacitance across mic_dia via contact 326 and mic_top via contact 334. The change of capacitance is sensed and is proportional to the sound pressure received.

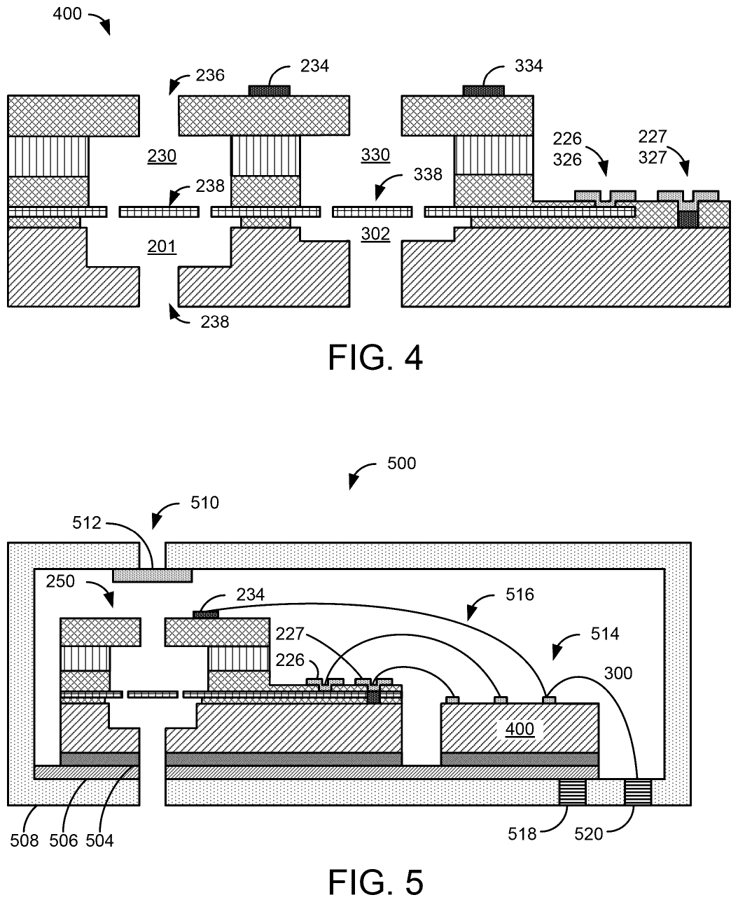

FIG. 4 illustrates another embodiment including two different devices. In this embodiment, a device 400 is illustrated including elements of a micro speaker from FIG. 2, and elements of a microphone from FIG. 3. As can be seen, the depth of cavity 302 is much shallower than the depth of cavity 201, this enables higher sensitivity in the microphone. Other examples may be envisioned, for example having multiple speakers, e.g., different frequency ranges, having different microphones, e.g., different ranges of sensitivity (for high dynamic sensitivity), and combinations thereof. Other embodiments may include other MEMS type of devices such as accelerometers, gyroscopes, and the like, in addition to speakers and/or microphones. Such other MEMS devices may also utilize the flexible material used for the diaphragms of the speakers or microphones, as a proof mass, or the like.

FIG. 5 illustrates a System in Package (SIP) embodiment. In various embodiments, the contact pads (e.g., 226, 227 or 326 and 327) are locations where micro speaker 250 or microphone 300 may be electrically coupled to a separate CMOS die or electrical device 500, and contact pads (e.g., 226, 227) may be locations where wafer 200 will support external wire bonds. Contact pads on CMOS die 500 may be aluminum or other contact material.

In various embodiments, the audio device shown in FIG. 2D or FIG. 3 may be coupled via an interposer material 504 (e.g., epoxy, resin) to a printed circuit board (e.g., PCB) 506 as shown in FIG. 5 to form System in Package (SIP). In various embodiments, a metal housing 508 may be coupled to PCB 506 to provide electrical contacts and isolation of combined wafer 250, 500, and the like. Metal housing 508 typically includes one or more opening 510 where sound pressure from micro speaker 350 can exit metal housing 508 and where sound pressure from external sources can reach microphone 300. Opening 510 may include a mesh-like material 512 that reduces humidity, dust, dirt or other contaminants from entering housing 508.

In various embodiments, PCB 506 may include a number of metallic contacts or terminals, e.g., 518. In various embodiments, the metallic contacts may be electrically coupled to circuitry or contacts within wafer 250, 300, 500 etc. In one example, wire bonds, e.g., gold wires 516 are coupled to contact pads, e.g., 514, 226, 227, 234, and the like.

In various embodiments, product level testing and sorting of devices can be performed by applying signals and receiving data from external test systems via the exposed CMOS bond pads, e.g., 226, 227 etc. or through SIP pads 418, 420 etc. This testing may be advantageously performed prior to die singulation.

Further embodiments can be envisioned to one of ordinary skill in the art after reading this disclosure. In some embodiments, the wafer identified as wafer 106 may simply be a wafer with metallic interconnects, and may include active devices, e.g., transistors, driving circuitry, sensing circuitry, and the like. Bonding of contacts between MEMS wafer 102 and wafer 104 may be performed with polymer bonds or other types of conductive bonds.

In other embodiments, multiple MEMS speakers or MEMS microphones or additional MEMS sensors may be formed upon a common MEMS handle wafer 106, using the processes disclosed above. In some embodiments, one MEMS speaker may be optimized for one band of audio output (e.g., midrange), one MEMS speaker may be optimized for another band of audio output (e.g., bass), and the like. In some cases, frequency band directed/cross-over functionality may be implemented by active and/or passive devices formed within a CMOS wafer, within MEMS handle wafer 106, or via external devices, e.g., discrete passive capacitors, inductors, resistors, and the like disposed upon PCB 406, for example. Additionally, in still other embodiments, one or more MEMS microphones and one or more MEMS speakers may be formed monolithically as was illustrated in the figures above. In some embodiments, the flexible material layer may be a diaphragm for a speaker, a microphone, a pressure sensor, a proof mass for an accelerometer, or the like.

The block diagrams of the architecture and flow charts are grouped for ease of understanding. However, it should be understood that combinations of blocks, additions of new blocks, re-arrangement of blocks, and the like are contemplated in alternative embodiments of the present invention. The specification and drawings are, accordingly, to be regarded in an illustrative rather than a restrictive sense. It will, however, be evident that various modifications and changes may be made thereunto without departing from the broader spirit and scope of the invention as set forth in the claims.

We claim:

1. A method for forming a Micro-Electromechanical System (MEMS) audio device comprising:
receiving a first wafer characterized by an upper portion and a lower portion, wherein a first cavity is formed within the upper portion of the first wafer;
disposing a second wafer upon the first wafer, wherein the second wafer comprises a semiconductor material having a first side and a second side, wherein a diaphragm is formed from a portion of the semiconductor material, wherein the diaphragm is disposed above the first cavity, and wherein the first side of the second wafer is directed towards the upper portion of the first wafer; and
disposing a third wafer on top of the second wafer via a thickness of an adhesive material, wherein the third wafer comprises a bottom side and an upper side, wherein the bottom side of the third wafer is directed towards the second side of the second wafer, wherein a second cavity is formed therebetween, wherein the second cavity is disposed above the diaphragm;
wherein the diaphragm for the MEMS audio device is configured to move out of plane relative to the semiconductor material and within the first cavity and the second cavity.

2. The method of claim 1, wherein the MEMS audio device is selected from a group consisting of: a speaker and a microphone.

3. The method of claim 1, wherein the adhesive material is selected from a group consisting of: a polymer, an epoxy, a photoresist.

4. The method of claim 1, wherein the adhesive material comprises Perminex.

5. The method of claim 1 where the adhesive material is dispensed as a liquid or used as an adhesive film.

6. The method of claim 1
wherein the second wafer comprises a silicon on insulator wafer; and
wherein the first wafer and the second wafer together form a cavity Silicon on Insulator (SOI) wafer.

7. The method of claim 1, wherein an electrode is configured using the silicon of the first wafer or a conductive surface deposited on the first wafer to provide an electrostatic force relative to the movable diaphragm, wherein movement of the movable diaphragm in response thereto is configured to generate acoustic signals.

8. The method of claim 1, wherein the third wafer comprises a semiconductor wafer having an electrical connection disposed upon the upper side of the third wafer.

9. The method of claim 1 further comprising providing vapor hydrofluoric acid into the first and the second cavity to thereby expose the diaphragm.

10. The method of claim 1, further comprising:
performing a first deep reactive ion etching (DRIE) process to the first wafer to form a vent hole into the first cavity; and
performing a second deep reactive ion etching (DRIE) process to the third wafer to form a vent hole into the second cavity.

11. The method of claim 1, wherein a thickness of the adhesive material is within a range of 1 to 40 microns.

12. The method of claim 1,
wherein a third cavity is formed within the upper portion of the first wafer;
wherein another diaphragm is formed from another portion of the semiconductor material of the second wafer, wherein the other diaphragm is disposed above the third cavity;
wherein a fourth cavity is formed between the first third wafer and the second wafer;
wherein the other diaphragm for the MEMS audio device is configured to move out of plane relative to the semiconductor material and within the third cavity and the fourth cavity;
wherein the diaphragm is used for a speaker; and
wherein the other diaphragm is used for a microphone.

13. The method of claim 1, where a Cavity Silicon on Insulator (C-SOI) wafer may be used in place of the first and the second wafer.

14. The method of claim 1, where partial trenches are created between the wafers forming a cavity to control pressure in the cavity or differential stress on the diaphragm.

15. The method of claim 1, where area of the bonded wafers without cavity is used as a capacitor.

16. The method of claim 1, where additional oxide or other dielectric is deposited in the regions other than cavities in order to minimize parasitic capacitance.

17. A Micro-Electromechanical System (MEMS) audio device comprising:
a first wafer characterized by a first surface comprising a first cavity and a second surface having at least a first vent hole formed through the first wafer and coupled to the first cavity, wherein the first surface comprises a first plurality of electrical contacts;
a second wafer disposed upon the first surface of the first wafer, wherein the second wafer is characterized by a flexible material layer, wherein a portion of the flexible material layer is disposed above the first cavity of the first wafer;
a third wafer coupled to the second wafer using an insulating material, wherein the third wafer includes a second cavity, and having at least a second vent hole formed through the third wafer and coupled to the second cavity;
wherein the first portion of the flexible material forms a diaphragm for the MEMS audio device.

18. The device of claim 17 wherein the MEMS audio device is selected from a group consisting of: a speaker and a microphone.

19. The device of claim 17
wherein the first surface of the first wafer also comprises a second cavity;
wherein another portion of the flexible material layer of the second wafer is disposed above the second cavity of the first wafer;
where the other portion of the flexible material forms a portion of a device selected from a group consisting of: a microphone, an accelerometer, and a pressure sensor.

20. A micro-speaker device comprising:
a movable diaphragm device composed of one or more sequentially deposited thin films from a first group consisting of: silicon, polysilicon, silicon nitride, or graphene material, and comprising a total thickness of 0.1 nm to ten microns, and configured spatially within a cavity region, the movable diaphragm device having a first surface and a second surface opposite of the first surface, wherein the movable diaphragm is coupled to at least two flexible supports selected from a second group consisting of: cantilever and springs, wherein each flexible support is coupled between a peripheral region of the movable diaphragm device and a portion of a frame disposed adjacent to the movable diaphragm device;
a substrate device coupled to the frame, wherein a first electrode is configured using the substrate or an electrically conductive material deposited on the substrate to provide an electrostatic force relative to the movable diaphragm, wherein movement of the movable diaphragm in response thereto is configured to generate acoustic signals; the substrate device includes a first vent and a first cavity configured to allow back pressure to flow therethrough; and
a cap electrode is coupled to the frame with an insulating material selected from a third group consisting of: epoxy, a polymer, and an adhesive, wherein the cap electrode includes a second vent and a second cavity region is formed between the cap electrode and the movable diaphragm device, wherein a height of the second cavity is determined in response to a thickness of the insulating material, and wherein the cap electrode includes an electrode on a top surface of the cap electrode;
wherein the cap electrode is configured to provide an electrostatic force relative to the movable diaphragm, wherein movement of the movable diaphragm in response thereto is configured to generate acoustic signals from the first vent or the second vent.
